(19) United States
(12) Patent Application Publication
(10) Pub. No.: US 2021/0286531 A1
(43) Pub. Date: Sep. 16, 2021

(54) ULTRA-SECURE OFFLINE DATA PROTECTION FOR A DATACENTER

(71) Applicant: Microsoft Technology Licensing, LLC, Redmond, WA (US)

(72) Inventors: Jason David ADRIAN, Woodinville, WA (US); Nicholas Andrew KEEHN, Kirkland, WA (US)

(21) Appl. No.: 16/817,929

(22) Filed: Mar. 13, 2020

(51) Int. Cl. G06F 3/06; G06F 16/23; G06F 16/28

(52) U.S. Cl. CPC G06F 3/0622; G06F 16/2372; G06F 3/067; G06F 3/0604; G06F 16/283

(57) ABSTRACT

To create secured offline data that is inaccessible by any computing devices external to a datacenter, a system includes an offline storage area for the datacenter. The offline storage area is distinct from a production area of the datacenter. The system also includes an offline storage unit that is configured to include storage media items that have been designated for offline storage. The storage media items include data from the datacenter. An automated system that operates within the production area of the datacenter is configured to transfer the storage media items into the offline storage unit. The system also includes a unidirectional security system that prevents the automated system from removing the storage media items from the offline storage unit after the storage media items have been moved into the offline storage area, thereby making the storage media items inaccessible to the automated system.

### CROSS-REFERENCE TO RELATED APPLICATIONS

N/A

### BACKGROUND

A datacenter is a physical facility that is used to house an organization's computer systems and associated components. Many organizations have one or more datacenters. A datacenter for a large organization can include a large number of servers, which can be stacked in racks that are placed in rows.

Cloud computing is the delivery of computing services (e.g., servers, storage, databases, networking, software, analytics) over the Internet. Cloud computing providers typically have a large number of datacenters in many different geographical areas.

Some cloud computing providers offer services related to backing up or archiving data. A backup is a copy of current data that can be used to restore original data if it is ever damaged. An archive typically includes data that is not currently needed but should be saved so that it can be accessed in the future, if necessary.

It can be desirable to provide an air gap for backed up or archived data. The term “air gap” can refer to offline storage of data or asynchronous access to data that would allow time to detect a malicious attack and reduce the odds of data being compromised. Only storage media that is offline and inaccessible to any of a datacenter's automated systems (e.g., an automated robotics system) is truly air gapped. Air gapped storage media can only be restored by human intervention, thus making remote hacks nearly impossible.

While magnetic tape and other removable storage media have the potential to provide an air gap, keeping the media inside certain parts of a datacenter (e.g., a storage library that is accessible to building level automation) only slows potential attacks. When data having high security requirements is backed up or archived to removable storage media, the removable storage media are often removed from the storage library and stored elsewhere, even offsite, which physically prevents data corruption or theft. This is often labor intensive, has the potential for human error, and has risk of loss if the media is transported offsite.

### SUMMARY

One aspect of the present disclosure is related to a system for facilitating storage of data from an automated system of a datacenter to a secure offline storage space to create secured offline data that is inaccessible by the automated system or any computing devices external to the datacenter. The automated system operates within a production area of the datacenter, and is accessible by one or more computing devices external to the datacenter with a computer network. The system includes an offline storage area for the datacenter. The offline storage area is distinct from a production area of the datacenter. The system also includes an offline storage unit that is configured to include storage media items that have been designated for offline storage. The storage media items include data from the datacenter. The automated system is configured to transfer the storage media items into the offline storage unit. The system also includes a unidirectional security system that prevents the automated system from removing the storage media items from the offline storage unit after the storage media items have been moved into the offline storage area, thereby making the storage media items inaccessible to the automated system.

In some embodiments, the offline storage unit includes a container with a plurality of slots. The unidirectional security system can include a spring-loaded detent in front of each slot.

Object identifiers may be associated with the storage media items. The offline storage area may include an object identifier reader that is configured to read the object identifiers.

The system may further include a computer system that is configured to receive a request to move a storage media item out of the offline storage area. The request may include a unique key associated with the storage media item. The computer system may also be configured to identify the storage media item based at least in part on the unique key.

The system may further include a media exchange interlock area that is adjacent to the offline storage area. Any storage units that are scheduled to leave the datacenter may be transferred from the offline storage area into the media exchange interlock area. No items in the media exchange interlock area may be permitted to leave the media exchange interlock area unless a plurality of security requirements have been satisfied.

The system may further include a computer system and a media exchange interlock area that is adjacent to the offline storage area. The computer system may be configured to cause an X-ray machine within the media exchange interlock area to take an X-ray of the media exchange interlock area in response to a plurality of storage units being moved into the media exchange interlock area. The computer system may also be configured to perform image processing on the X-ray to determine how many storage media items are in the media exchange interlock area.

The system may further include a computer system and a media exchange interlock area that is adjacent to the offline storage area. The computer system may be configured to cause a scale within the media exchange interlock area to weigh a plurality of storage units in the media exchange interlock area in response to the plurality of storage units being moved into the media exchange interlock area. The computer system may also be configured to determine whether a measured weight of the plurality of storage units matches an estimated weight of the plurality of storage units based on the storage media items that have been authorized to leave the offline storage area.

The system may further include an additional automated system within the offline storage area that is configured to transfer the storage media items between a plurality of storage units and transfer the plurality of storage units from the offline storage area to a media exchange interlock area that is adjacent to the offline storage area.

The system may further include a media exchange interlock area that is adjacent to the offline storage area and an additional automated system within the media exchange interlock area. The additional automated system may be configured to transfer a plurality of storage units from the media exchange interlock area to a loading dock for transfer outside of the datacenter.

The offline storage area may include a receiving area that is positioned to receive the storage media items from the automated system. The offline storage area may also include a conveyor system that is configured to move the storage media items in a direction away from the receiving area as additional storage media items are added to the receiving area.

The offline storage unit may include a mobile cart. The offline storage area may be located within the mobile cart. The mobile cart may be configured to dock with a storage library of the datacenter.

The automated system may be part of a storage library of the datacenter. The mobile cart may include a receiving area that is positioned to receive the storage media items from the automated system of the storage library. The unidirectional security system may be positioned at a boundary between the storage library of the datacenter and the receiving area.

Object identifiers may be associated with the storage media items. The mobile cart may include an object identifier reader that is configured to read the object identifiers.

The mobile cart may include at least one of a global positioning system (GPS) transponder or a locking mechanism.

Another aspect of the present disclosure is related to a method for facilitating secure transfer of offline data out of an offline storage area of a datacenter. The method includes receiving a request to move a storage media item out of the offline storage area of the datacenter. The request includes a unique key associated with the storage media item. The method also includes identifying the storage media item to be moved based at least in part on the unique key. The method also includes causing a storage unit including the storage media item to be moved from the offline storage area to a media exchange interlock area. The method also includes determining whether a plurality of security requirements associated with the media exchange interlock area have been satisfied. The method also includes moving the storage unit out of the media exchange interlock area only after confirming that the plurality of security requirements associated with the media exchange interlock area have been satisfied.

Determining whether the plurality of security requirements have been satisfied may include determining whether a datacenter computer system has authorized the storage unit to be removed from the offline storage area. Determining whether the plurality of security requirements have been satisfied may also include at least one additional security requirement selected from determining whether a number of storage media items in the media exchange interlock area matches the number of storage media items that are supposed to be leaving the offline storage area, determining whether an amount of weight in the media exchange interlock area matches an estimated weight that is calculated based on the number of storage media items that are supposed to be leaving the offline storage area, determining whether a security staff member has physically unlocked an opening leading out of the media exchange interlock area, or determining whether an opening to the offline storage area is closed.

The method may be implemented by a computer system associated with the datacenter. The computer system may not support queries to list contents of the offline storage area. The method may further include denying an additional request based at least in part on determining that no key has been submitted with the additional request or that a key submitted with the additional request is invalid.

Another aspect of the present disclosure is related to a mobile cart for facilitating secure offline storage of data from a datacenter. The mobile cart includes an offline storage area for the datacenter. The mobile cart also includes a receiving area that is configured to receive storage media items from an automated system of a storage library within the datacenter. The storage media items include data from the datacenter. The mobile cart also includes a unidirectional security system that prevents the automated system from removing the storage media items from the mobile cart after the storage media items have been placed in the receiving area. The mobile cart also includes a conveyor system that is configured to move the storage media items in a direction away from the receiving area as additional storage media items are added to the receiving area. The mobile cart also includes an object identifier reader that is configured to read object identifiers that are associated with the storage media items. The mobile cart also includes a computer system that is in electronic communication with the object identifier reader and that is configured to respond to requests for information about the storage media items within the mobile cart.

The mobile cart may further include least one of a global positioning system (GPS) transponder and a locking mechanism.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates an example of a datacenter that is designed with building-scale automation systems that implement at least some of the techniques disclosed herein.

FIG. 2 is a perspective view illustrating an example of one possible implementation of a storage unit in the datacenter shown in FIG. 1.

FIG. 2A is a side view of the container shown in FIG. 2, illustrating one implementation of a unidirectional security system that prevents removal of a storage media item from a storage unit.

FIG. 3 is a block diagram illustrating various components that can be included within a datacenter that is configured to implement at least some of the techniques disclosed herein.

FIG. 4 illustrates an example of a method that can be implemented to move one or more storage media items from a production area of a datacenter to an offline storage area of the datacenter.

FIG. 5 illustrates an example of a method that can be implemented in response to a request to move one or more storage media items out of the offline storage area.

FIG. 6 illustrates an embodiment in which some of the storage media items within an offline storage area are loaded onto a mobile cart.

FIG. 7 illustrates an example of a mobile cart that is configured to dock next to a storage library used by a datacenter.

FIG. 8 illustrates an example of a mobile cart that is configured to dock inside of a storage library used by a datacenter.

FIG. 9 illustrates an example of a system that includes an offline storage area within a mobile cart.

FIG. 10 illustrates certain components that can be included within a computer system.

### DETAILED DESCRIPTION

The present disclosure is generally related to providing highly secure offline data storage for a datacenter. The techniques disclosed herein can be used to provide a true air gap for data within a datacenter that should be backed up or archived.

The techniques disclosed herein can be used in connection with any type of storage media that would be appropriate for backing up or archiving data. Some examples of storage media that are commonly used today for backing up or archiving data include magnetic tape, optical discs, and hard disk drives. Other examples of storage media that could be used in the future for backing up or archiving data include glass and DNA. The techniques disclosed herein can be used in connection with the types of storage media that have been specifically mentioned as well as other types of storage media that could become available in the future.

Broadly speaking, the techniques disclosed herein can be utilized in at least two different types of scenarios. A first scenario involves a datacenter architecture that is specifically designed with building-scale automation systems that implement at least some of the techniques disclosed herein. A second scenario involves the use of mobile carts that dock with existing storage libraries used by datacenters. This second scenario does not require integration with building-scale automation systems.

In the first scenario just described, a datacenter can be designed with an automated system (e.g., a robotics system) that can access large numbers (e.g., thousands or hundreds of thousands) of pieces of storage media. To create the offline capability, a separate secure area within the datacenter can be created. This secure area may be referred to herein as an offline storage area. The offline storage area can be separated from the main production area of the datacenter. When particular items of storage media have been designated for offline storage, the datacenter's automated system can transfer the storage media items into storage units within the offline storage area.

The storage media can be transferred from the automated system into the offline component of the mobile cart through a unidirectional security system that prevents the datacenter's automated system from removing the storage media items from the storage unit after the storage media items have been placed in the offline storage area. The unidirectional security system can be designed so that the transfer of the storage units from the datacenter's automated system into the offline storage area occurs in one direction only. The unidirectional security system can include one or more mechanical features that restrict movement of the storage media items to one direction only. In other words, the unidirectional security system can permit movement of the storage media items into the storage container, but restrict movement of the storage media items out of the storage container.

The offline storage area can include various components that enable the storage media items in the storage units to be tracked. In some embodiments, each storage media item can be associated with an object identifier (e.g., a barcode, a radio-frequency identification (RFID) tag, a near-field communication (NFC) tag), and the offline storage area can include an object identifier reader that is configured to read the object identifiers associated with the items of storage media.

In some embodiments, the datacenter can be operated by a cloud computing provider. Consequently, the datacenter can store data for many different organizations and individuals. The cloud computing provider can provide an interface (e.g., a web interface) through which data owners can request offline storage of particular data (e.g., as a backup or archive). This interface can also allow data owners to make certain requests related to offline storage, such as requests related to storage media in the offline storage area. The datacenter can include one or more computer systems that are configured to process such requests.

In some embodiments, once an item of storage media is in a storage unit within the offline storage area, a unique key associated with that item of storage media could be required in order to request the storage media to be moved back online (e.g., back into the production area), or to physically export the storage media outside the datacenter. The datacenter's computer system can decode the key (possibly in combination with user account information) to identify the piece of storage media, if it exists. By not allowing the ability to request a list of media, this adds another layer of security from malicious attacks.

The storage units that store the media can be configured to provide inherent security, traceability, and organization while reducing labor and risk of error. There are many different ways that the storage units disclosed herein can be implemented. Some examples of possible implementations of the storage units include containers with slots, pallets, and mobile carts.

Implementing the storage units as mobile carts can enable a low cost and scalable solution that is also portable if data needs to be physically moved to another site. In some embodiments, the mobile carts can be configured to track which media they contain, thereby providing a fully traceable chain of custody from the online datacenter to a secure offsite location.

Another aspect of the present disclosure is related to facilitating the secure transfer of storage media out of the datacenter for storage in a different physical location. In some embodiments, the datacenter can also include a media exchange interlock area that is adjacent to the offline storage area. The datacenter can be designed in such a way that any storage media items that are scheduled to leave the datacenter are transferred from the offline storage area into the media exchange interlock area. In addition, the media exchange interlock area can be configured so that none of the storage media items in the media exchange interlock area are permitted to leave the media exchange interlock area unless several security requirements have been satisfied. For example, one requirement can be that all storage media items that are present in the media exchange interlock area have been approved for removal by the datacenter's computer system. Other security requirements can be related to verifying that only storage media items that have been approved to leave the datacenter are present in the media exchange interlock area.

In the second scenario discussed above (the scenario that does not require integration with building-scale automation systems), a secure mobile cart could dock with a datacenter's storage library. The cart could dock next to the storage library or even dock inside of it for better integration. When offline storage of particular data is desired, drives within the storage library can write the data to storage media and deliver the storage media to the secure mobile cart via an automated system that is built into the storage library.

As with the first scenario, the storage media can be transferred from the automated system into the offline component of the mobile cart through a unidirectional security system that prevents the automated system from removing the storage media from the mobile cart after the storage media items have been moved into the offline storage area. Therefore, the offline component of the mobile cart can be fully isolated from the datacenter's storage library. The unidirectional security system can include one or more mechanical features that restrict movement of the storage media items to one direction only. To retrieve media from the offline component of the cart, an access door with a physical locking mechanism (e.g., a key-based mechanism) would only be accessible by authorized personnel.

The mobile cart could also be used to keep track of offline storage media. Media tracking could be performed by the cart via a contactless technology such as NFC or RFID without any capability to read the data in the storage media. Furthermore, the mobile cart could be easily transported securely to external facilities, such as those belonging to the owner of the offline data. Since the mobile cart can report on which storage media it contains, it can provide a seamless and secure chain of traceability for all such storage media. In some embodiments, this capability can be further enhanced by incorporating a global positioning system (GPS) transponder into the mobile cart for traceability of the mobile cart itself.

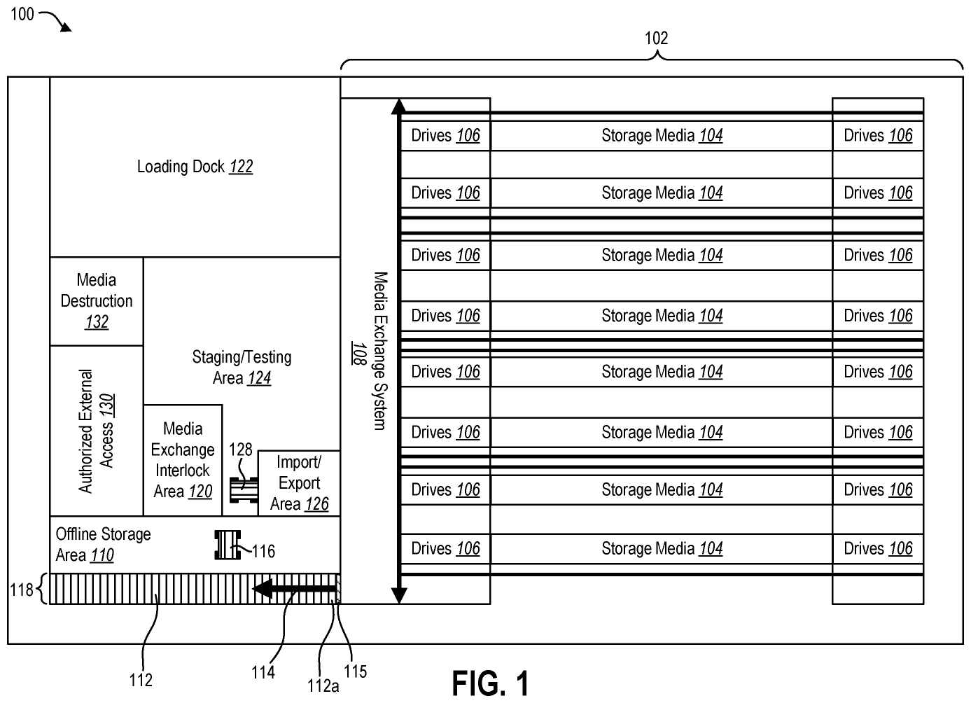

FIG. 1 illustrates an example of a datacenter 100 that is designed with building-scale automation systems that implement at least some of the techniques disclosed herein. In particular, FIG. 1 is a top-down view of the datacenter 100, illustrating various areas within the datacenter 100.

The datacenter 100 includes a production area 102, which includes a plurality of servers (not shown) that include data. These servers are accessible to computing devices external to the datacenter 100 via one or more computer networks, such as the Internet. In some embodiments, the datacenter 100 can be operated by a cloud computing provider. The servers within the production area 102 of the datacenter 100 can be used to provide computing services over the Internet.

The production area 102 also includes storage media 104 for backing up or archiving data that is stored on the servers within the production area 102 of the datacenter 100. In the depicted embodiment, the production area 102 includes a plurality of rows of storage media 104, with drives 106 located at both ends of each row. The drives 106 are configured to write backup or archive data to the storage media 104. As discussed previously, the storage media 104 may take the form of any type of storage media 104 that would be appropriate for backing up or archiving data. The drives 106 are configured to write data to the type of storage media 104 that is being used. For example, if the storage media 104 includes magnetic tape, the drives 106 would include magnetic tape drives. As another example, if the storage media 104 includes optical discs, the drives 106 would include optical disc drives.

The datacenter 100 is designed with an automated system (e.g., a robotics system) that is operable within the production area 102 of the datacenter 100 and that is capable of accessing the storage media 104 and moving the storage media 104 into the drives 106. This type of automated system is represented by the media exchange system 108 in FIG. 1.

The datacenter 100 also includes an offline storage area 110 that is distinct from the production area 102 of the datacenter 100. In some embodiments, the offline storage area 110 can be physically separated from the production area 102 of the datacenter 100. The offline storage area 110 can function as a designated place for keeping storage media 104 that has been designated for offline storage. When particular items of storage media 104 have been designated for offline storage, the media exchange system 108 can transfer the items of storage media 104 to the offline storage area 110.

In the depicted embodiment, items of storage media 104 can be transferred into storage units 112 within the offline storage area 110. Advantageously, the transfer of the items of storage media 104 from the media exchange system 108 into the storage units 112 can occur through a unidirectional security system 115. The unidirectional security system 115 can include one or more mechanical features that restrict movement of the items of storage media 104 to one direction only. Therefore, the unidirectional security system 115 permits movement of the storage media items 104 into the offline storage area 110, but restricts movement of the storage media items 104 out of the offline storage area 110. In this way, the unidirectional security system 115 prevents the media exchange system 108 from being able to access the items of storage media 104 after they have been moved into the offline storage area 110. Consequently, the transfer of the items of storage media 104 from the media exchange system 108 into the offline storage area 110 occurs in one direction only.

One benefit of the unidirectional security system 115 is to ensure that the items of storage media 104 are no longer accessible to the media exchange system 108 after the items of storage media 104 have been placed in a storage unit 112. This is beneficial because it significantly reduces the likelihood that someone could gain unauthorized access to the items of storage media 104.

When users designate data for offline storage, the security of the data can be quite significant. Data that is designated for offline storage often includes highly sensitive information. Users want to be able to trust that offline data will not be accessed without authorization. However, as long as the items of storage media 104 are accessible to the media exchange system 108, then it is possible for an unauthorized user (such as a hacker) to remotely gain access to the data that is stored on the items of storage media 104. For example, in many cases, it is possible for sophisticated hackers with specialized knowledge to access a media exchange system 108 of a datacenter 100 via one or more computer networks (e.g., the Internet). Consequently, it is possible that an unauthorized user could remotely gain access to the media exchange system 108. Therefore, any items of storage media 104 that are accessible to the media exchange system 108 can potentially be accessed via one or more computing devices that are external to the datacenter 100 and that can access to the media exchange system 108. An unauthorized user could gain access to the media exchange system 108 and cause the media exchange system 108 to insert the items of storage media 104 into the drives 106. This would allow the unauthorized user to potentially be able to access the data on the items of storage media 104.

Ensuring that the items of storage media 104 are no longer accessible to the media exchange system 108 can be beneficial because it prevents an unauthorized user from being able to access the items of storage media 104 once they have been moved into the offline storage area 110. Therefore, providing a unidirectional security system 115 between the production area 102 of the datacenter 100 and the offline storage area 110 makes it possible for users to reliably trust that the offline data is truly offline and will not be accessed without authorization.

The unidirectional security system 115 can be implemented in a variety of different ways. As one example, the storage units 112 can take the form of containers. A plurality of slots can be included in each container. The unidirectional security system 115 can include a spring-loaded detent in front of each slot.

As another example, the unidirectional security system 115 can include a one-way conveyor belt system. The conveyor belt system can be configured to move in one direction only. It can be mechanically restricted from moving in the opposite direction.

As another example, the unidirectional security system 115 can include a one-way roller system. Similar to the conveyor belt system, the roller system can be configured to move in one direction only. It can be mechanically restricted from moving in the opposite direction.

As another example, the unidirectional security system 115 can be implemented as a carousel system. The carousel system could include a circular platform that rotates in only one direction. Some portion of the circular platform could be located in the production area 102 of the datacenter 100, while another portion of the circular platform could be located in the offline storage area 110. Items of storage media 104 could be placed onto the portion of the circular platform that is located in the production area 102 of the datacenter. The circular platform could then be rotated so that the items of storage media 104 are moved into the offline storage area 110. One or more barriers could be situated so as to prevent the items of storage media from being permitted back into the production area 102 as the circular platform continues to be rotated.

As another example, the unidirectional security system 115 can include a container that can only have one side open at a time, similar to the way that a bank teller box operates. Such a container could be configured to slide back and forth between the production area 102 and the offline storage area 110.

FIG. 1 shows a row 118 of storage units 112 within the offline storage area 110. The media exchange system 108 loads items of storage media 104 into the storage unit 112a that is on the far-right end of the row 118. When this storage unit 112a is full, then all of the storage units 112 in the row 118 can be shifted in a direction 114 away from the media exchange system 108. In some embodiments, the offline storage area 110 can include a conveyor system (not shown in FIG. 1) that causes the storage units 112 to be shifted. When the row 118 of storage units 112 is full, then one or more of the storage units 112 within the row 118 can be moved to another location within the offline storage area 110. FIG. 1 shows a mobile cart 116 in the offline storage area 110. The mobile cart 116 can be used to move storage units 112 from the row 118 to other locations within the offline storage area 110.

In an alternative embodiment, instead of having the media exchange system 108 place items of storage media 104 into storage units 112, the media exchange system 108 can pass items of storage media 104 through slots in a wall between the production area 102 and the offline storage area 110. An automated system within the offline storage area 110 can then place the items of storage media 104 into storage units 112.

Under some circumstances, items of storage media 104 can be securely transferred out of the offline storage area 110. For example, a data owner could request that certain items of storage media 104 in the offline storage area 110 be transferred to an offsite location outside of the datacenter 100. As another example, a data owner could request that certain items of storage media 104 in the offline storage area 110 be restored, which can involve transferring those items of storage media 104 from the offline storage area 110 back into the main production area 102.

To facilitate secure transfer of items of storage media 104 outside of the offline storage area 110, the datacenter 100 can also include a media exchange interlock area 120 that is adjacent to the offline storage area 110. The datacenter 100 can be designed in such a way that any items of storage media 104 that are scheduled to leave the datacenter 100 are transferred from the offline storage area 110 into the media exchange interlock area 120. For example, in some embodiments, the offline storage area 110 can be designed with only one exit, and this exit can lead to the media exchange interlock area 120.

The media exchange interlock area 120 can be configured so that none of the items of storage media 104 in the media exchange interlock area 120 are permitted to leave the media exchange interlock area 120 unless several security requirements have been satisfied. Some examples of these security requirements will be described below. These security requirements make it even less likely that an unauthorized user could access any of the items of storage media 104 in the offline storage area 110.

The datacenter also includes a loading dock 122. The loading dock 122 can be an area where items of storage media 104 that are being transferred to an offsite location can be loaded onto one or more vehicles that will transport the items of storage media 104 to the offsite location. Once one or more storage units 112 containing items of storage media 104 that are being transferred to an offsite location have been authorized to leave the media exchange interlock area 120, they can be transferred to the loading dock 122. In the embodiment shown in FIG. 1, storage units 112 that leave the media exchange interlock area 120 pass through a staging/testing area 124 before they reach the loading dock 122. In an alternative embodiment, the media exchange interlock area 120 can extend all the way to the loading dock 122, so that storage units 112 that have been authorized to leave the media exchange interlock area 120 can pass directly into the loading dock 122.

The datacenter 100 also includes an import/export area 126. The import/export area 126 can be an area where items of storage media 104 that are being restored can be processed. Once one or more storage units 112 containing items of storage media 104 that are being restored have been authorized to leave the media exchange interlock area 120, they can be transferred to the import/export area 126. In the embodiment shown in FIG. 1, storage units 112 that leave the media exchange interlock area 120 pass through the staging/testing area 124 before they reach the import/export area 126. In an alternative embodiment, the media exchange interlock area 120 can extend all the way to the import/export area 126, so that storage units 112 that have been authorized to leave the media exchange interlock area 120 can pass directly into the import/export area 126.

In an alternative embodiment, a datacenter can include two media exchange interlock areas: a first media exchange interlock area for items of storage media that are being transferred to an offsite location, and a second media exchange interlock area for items of storage media that are being restored. The first media exchange interlock area can extend from the offline storage area all the way to the loading dock, so that items of storage media that are being transferred to an offsite location can pass from the first media exchange interlock area directly into the loading dock (once they have been authorized to leave the first media exchange interlock area). The second media exchange interlock area can extend from the offline storage area all the way to the import/export area, so that items of storage media that are being restored can pass from the second media exchange interlock area directly into the import/export area (once they have been authorized to leave the second media exchange interlock area).

Returning to the discussion of the datacenter 100 shown in FIG. 1, there are many different ways that storage units 112 can be transferred from the offline storage area 110 into the media exchange interlock area 120, and from the media exchange interlock area 120 to the loading dock 122 or to the import/export area 126. For example, if the storage units 112 are implemented as containers or pallets, the offline storage area 110 can include an automated system that moves the containers or pallets from the offline storage area 110 into the media exchange interlock area 120. The mobile cart 116 shown in FIG. 1 is an example of an automated system that can move containers or pallets containing storage media items from the offline storage area 110 into the media exchange interlock area 120. Similarly, the media exchange interlock area 120 can include an automated system that moves containers or pallets of storage media items from the media exchange interlock area 120 to the loading dock 122 or to the import/export area 126 (once the security requirements of the media exchange interlock area 120 have been satisfied). FIG. 1 shows another mobile cart 128, which can be used to move the containers or pallets from the offline storage area 110 to the import/export area 126 or to the loading dock 122.

In some embodiments, the storage units 112 can be implemented as mobile carts, and the mobile carts can autonomously move from the offline storage area 110 into the media exchange interlock area 120, and from the media exchange interlock area 120 to the loading dock 122 or to the import/export area 126 (once the security requirements of the media exchange interlock area 120 have been satisfied).

The datacenter 100 shown in FIG. 1 also includes several other areas, including the staging/testing area 124, the authorized external access area 130, and the media destruction area 132. The staging/testing area 124 can be an area where new components (e.g., new computer hardware) that are going to be used in the datacenter 100 can be tested. The authorized external access area 130 can be an area designated for people who are not authorized to be in the other parts of the datacenter 100. For example, other parts of the datacenter 100 can be restricted to employees of the company that owns the datacenter 100. If there are components (e.g., computer hardware) within the datacenter 100 that should be serviced by someone who is not an employee of the company, the components can be brought to the authorized external access area 130 and serviced there. The media destruction area 132 can be an area where storage media 104 that is no longer needed can be destroyed.

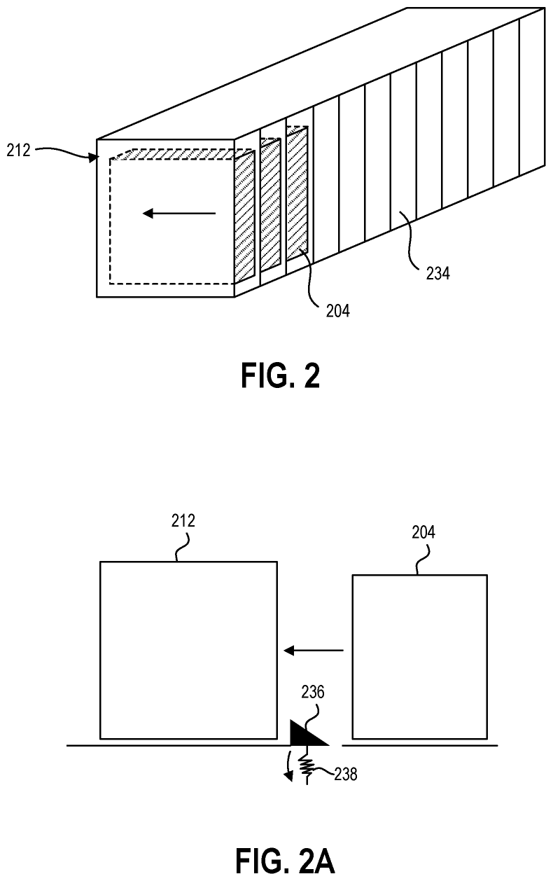

FIG. 2 is a perspective view illustrating an example of one possible implementation of a storage unit 112 in the datacenter 100 shown in FIG. 1. In the depicted example, the storage unit 112 is implemented as a container 212. The container 212 includes a plurality of slots 234. Items of storage media can be inserted into the slots 234 within the container 212.

FIG. 2A illustrates a side view of the container 212 shown in FIG. 2. In particular, FIG. 2A illustrates a storage media item 204 being inserted into a slot 234 within the container 212.

As discussed above, the transfer of storage media items 204 into storage units can occur through a unidirectional security system that prevents an automated system (such as the media exchange system 108 shown in FIG. 1) from removing storage media items 204 from a storage unit after the storage media items 204 have been moved into the offline storage area 110. This prevents an unauthorized user from being able to access the storage media items 204 once they have been moved into the offline storage area 110. In the depicted example, the unidirectional security system includes a spring-loaded detent 236 at the entrance of the slot 234 within the container 212. The detent 236 is a ramp-like structure. Moving a storage media item 204 over the detent 236 causes the detent 236 to be pushed in a downward direction, which causes a spring 238 to compress. When the storage media item 204 has passed over the detent 236, the force of the spring 238 pushes the detent 236 in an upward direction, thereby mechanically preventing the storage media item 204 from being removed from the container 212.

The spring-loaded detent 236 shown in FIG. 2A is just one example of a unidirectional security system, and it should not be interpreted as limiting the scope of the present disclosure. As discussed above, a unidirectional security system in accordance with the present disclosure can be implemented in many different ways.

In some embodiments, containers like the container 212 shown in FIGS. 2 and 2A can be used in the system 100 shown in FIG. 1. An empty container 212 can be placed on the far-right end of the row 118 within the offline storage area 110 (in the position of the storage unit 112a shown in FIG. 1). Once the container 212 is full (i.e., once a storage media item 204 has been placed in each slot 234), then all of the containers 212 in the row 118 can be shifted in a direction 114 away from the media exchange system 108. An empty container 212 can then be placed on the far-right end of the row 118 and filled with storage media items 204. As noted above, the offline storage area 110 can include a conveyor system (not shown in FIG. 1) that causes the storage units 112 to be shifted. Some examples of different types of conveyor systems that can be used will be discussed below.

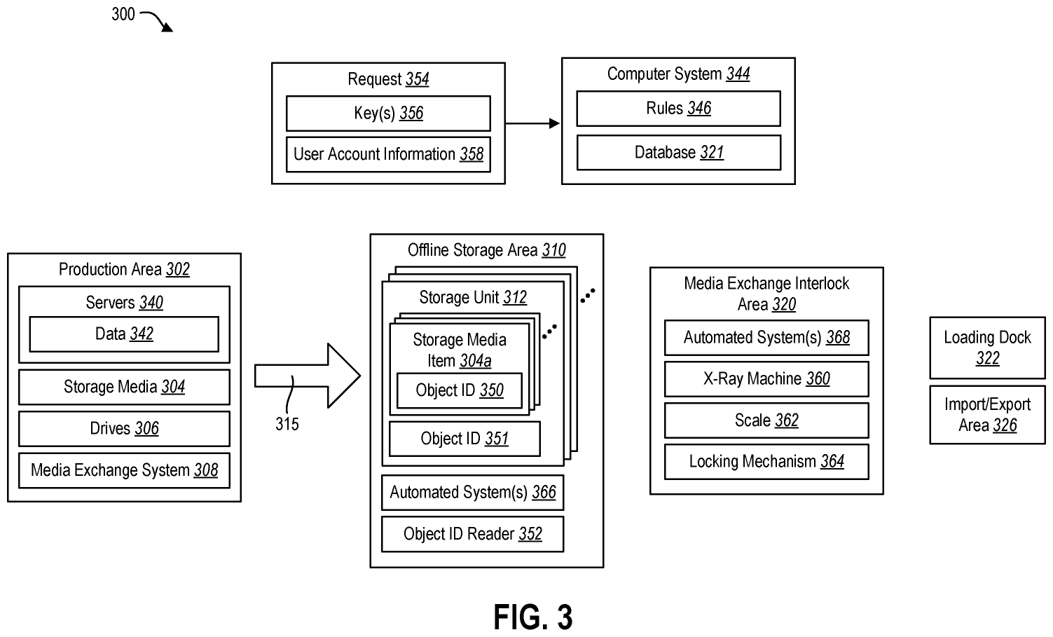

FIG. 3 is a block diagram illustrating various components that can be included within a datacenter 300 that is configured to implement at least some of the techniques disclosed herein. The datacenter 300 is similar in some respects to the datacenter 100 shown in FIG. 1. For example, it will be assumed that the datacenter 300 has been designed with building-scale automation systems that implement at least some of the techniques disclosed herein.

The datacenter 300 includes some of the same areas as the datacenter 100 shown in FIG. 1, including a production area 302, an offline storage area 310, a media exchange interlock area 320, a loading dock 322, and an import/export area 326.

A plurality of storage units 312 are shown in the offline storage area 310. Each storage unit 312 can be configured to store a plurality of storage media items 304a. Although the storage units 312 are shown in the offline storage area 310, storage units 312 can be located in other areas within the datacenter 300 (e.g., the media exchange interlock area 320, the loading dock 322, the import/export area 326).

The production area 302 of the datacenter 300 includes a plurality of servers 340 that include data 342. The production area 302 also includes storage media 304 for backing up or archiving at least some of the data 342 that is stored by the datacenter 300, as well as drives 306 that are configured to write backup or archive data to the storage media 304. The production area 302 can also include a media exchange system 308, which can be an automated system that functions similarly to the media exchange system 108 in the datacenter 100 shown in FIG. 1. A unidirectional security system 315 can be implemented between the production area 302 of the datacenter 300 and the offline storage area 310. As discussed above, the unidirectional security system 315 can be designed to prevent the media exchange system 308 from being able to access the items of storage media 304 after they have been moved into the offline storage area 310.

The datacenter 300 can include a computer system 344 that is configured to process requests related to offline data storage. The computer system 344 can be configured to process and respond to many different kinds of requests, including requests for offline storage of particular data 342 being stored by the datacenter 300, requests that certain storage media items 304a in the offline storage area 310 be transferred to an offsite location outside of the datacenter 300, requests that certain storage media items 304a in the offline storage area 310 be restored, and so forth. The computer system 344 can be programmed with various rules 346 for processing and responding to the various requests that are received.

In response to a request to designate particular items of storage media 304 for offline storage, the computer system 344 can cause the media exchange system 308 to transfer the items of storage media 304 to the offline storage area 310. As discussed above, the items of storage media 304 can be placed in one or more storage units 312.

Once a storage media item 304a has been placed in a storage unit 312, the storage media item 304a can be associated with a unique object identifier (ID) 350. The offline storage area 310 can include an object ID reader 352 that is configured to read the object IDs 350 that are associated with the storage media items 304a. The object ID reader 352 can be in electronic communication with the datacenter's computer system 344. This makes it possible for the computer system 344 to find out what storage media items 304a are in the offline storage area 310. For example, the object ID reader 352 can read the object IDs 350 that are associated with the storage media items 304a and communicate these object IDs 350 to the computer system 344. Although the object ID reader 352 can read the object IDs 350 that are associated with the storage media items 304a, the object ID reader 352 is not capable of reading the data that is stored on the storage media items 304a. Thus, once the storage media items 304a have been moved into the offline storage area 310, it is not possible to remotely access the data that is stored on the storage media items 304a. This increases the security of the offline data by further reducing the likelihood that someone could gain unauthorized access to the items of storage media 304.

In addition to associating object IDs 350 with particular storage media items 304a, each storage unit 312 can be associated with an object ID 351. In some embodiments, the computer system 344 can include a database 321 that indicates which storage media items 304a are included in which storage units 312. In some embodiments, it is possible to determine which storage media items 304a are included in a particular storage unit 312 by scanning the object ID 351 associated with that storage unit 312 and then looking up that object ID 351 in the database 321. In some embodiments, it is possible to determine where a particular storage media item 304a is located by entering the object ID 350 associated with that storage media item 304a into the database 321. The database 321 can provide the object ID 351 associated with the storage unit 312 that includes the storage media item 304a. In some embodiments, as will be discussed in greater detail below, a storage unit 312 can include a location tracking mechanism such as a GPS transponder. Therefore, in addition to providing the object ID 351 associated with the storage unit 312 that includes the storage media item 304a, the database 321 can also provide the location of the storage unit 312.

In some embodiments, when a storage media item 304a is in a storage unit 312 within the offline storage area 310, a unique key associated with that storage media item 304a can be required for the storage media item 304a to be moved back online (e.g., back into the production area 302), or to physically export the storage media item 304a outside the datacenter 300. In other words, the datacenter's computer system 344 can be configured so that it does not support the ability to list or query what is contained within the offline storage area 310. This further increases the security of the offline data. Unauthorized users are unlikely to know the specific kinds of data that are stored in the offline storage area 310. If the datacenter's computer system 344 did support the ability to list or query what is contained within the offline storage area 310, this could reveal potentially sensitive information. Preventing the datacenter's computer system 344 from revealing this information provides additional protection against unauthorized attacks.

FIG. 3 shows the datacenter's computer system 344 receiving a request 354 to transfer one or more storage media items 304a out of the offline storage area 310. Whenever the datacenter's computer system 344 receives such a request 354, the computer system 344 checks to see if the key(s) 356 associated with the storage media item(s) 304a have been provided. If a key 356 has not been provided, or if the key 356 that is provided is determined to be invalid, the request 354 to transfer the storage media item(s) 304a out of the offline storage area 310 can be denied. If, however, the request 354 to transfer the storage media item(s) 304a out of the offline storage area 310 does include the key(s) 356 associated with the storage media item(s) 304a, then the datacenter's computer system 344 can decode the key(s) 356 (possibly in combination with user account information 358) to identify the storage media item(s) 304a that should be transferred.

When storage media items 304a are authorized to be transferred out of the offline storage area 310, one or more storage units 312 containing the storage media items 304a to be transferred can be moved to the media exchange interlock area 320. As discussed above, the datacenter 300 can be designed so that none of the storage media items 304a in the media exchange interlock area 320 are permitted to leave the media exchange interlock area 320 unless several security requirements have been satisfied. These security requirements can be defined, at least in part, by rules 346 that are enforced by the datacenter's computer system 344. The datacenter's computer system 344 can communicate with other components within the datacenter 300 to enforce these rules 346. The media exchange interlock area 320 can include several components that make it possible to implement these security requirements.

For example, the security requirements for leaving the media exchange interlock area 320 can include a requirement that the number of storage media items 304a in the media exchange interlock area 320 matches the number of storage media items 304a that are supposed to be leaving. To facilitate this requirement, the media exchange interlock area 320 can include an X-ray machine 360. When one or more storage units 312 have been moved into the media exchange interlock area 320, the datacenter's computer system 344 can cause the X-ray machine 360 to take one or more X-rays of the media exchange interlock area 320 and provide the X-ray(s) to the datacenter's computer system 344. The datacenter's computer system 344 can perform image processing on the X-ray(s) to determine how many storage media items 304a are in the media exchange interlock area 320. The datacenter's computer system 344 can then determine whether the number of storage media items 304a that are actually present in the media exchange interlock area 320 matches the number of storage media items 304a that have been authorized to leave the offline storage area 310. If it does, then this security requirement can be deemed to have been satisfied.

As another example, the security requirements for leaving the media exchange interlock area 320 can include a requirement that the amount of weight in the media exchange interlock area 320 matches an estimated weight that is calculated based on the amount of storage media items 304a that are supposed to be leaving. To facilitate this requirement, the media exchange interlock area 320 can include a scale 362. When one or more storage units 312 have been moved into the media exchange interlock area 320, the datacenter's computer system 344 can cause the scale 362 to weigh the storage unit(s) 312 and provide the result to the datacenter's computer system 344. The datacenter's computer system 344 can then determine whether the weight of the storage unit(s) 312 matches an estimated weight of the storage unit(s) 312 based on the storage media items 304a that have been authorized to leave the offline storage area 310. If the actual weight matches the estimated weight, then this security requirement can be deemed to have been satisfied.

As another example, the security requirements for leaving the media exchange interlock area 320 can include a requirement that a security staff member should physically unlock an opening (e.g., a door, a slot) leading out of the media exchange interlock area 320. In addition, the security requirements for leaving the media exchange interlock area 320 can additionally specify that the opening should be unlocked from the outside of the media exchange interlock area 320, so that human personnel do not need to enter the media exchange interlock area 320. To facilitate this requirement, the media exchange interlock area 320 can include a locking mechanism 364 that can be unlocked from the outside of the media exchange interlock area 320.

As another example, the security requirements for leaving the media exchange interlock area 320 can include a requirement that a door (or other type of opening) between the offline storage area 310 and the media exchange interlock area 320 should be closed.

The datacenter 300 can include other automated systems in addition to the media exchange system 308. For example, the offline storage area 310 can include one or more automated systems 366 that are configured to move storage units 312 from the offline storage area 310 to the media exchange interlock area 320. The media exchange interlock area 320 can include one or more automated systems 368 that are configured to move storage units 312 from the media exchange interlock area 320 to the loading dock 322 or to the import/export area 326.

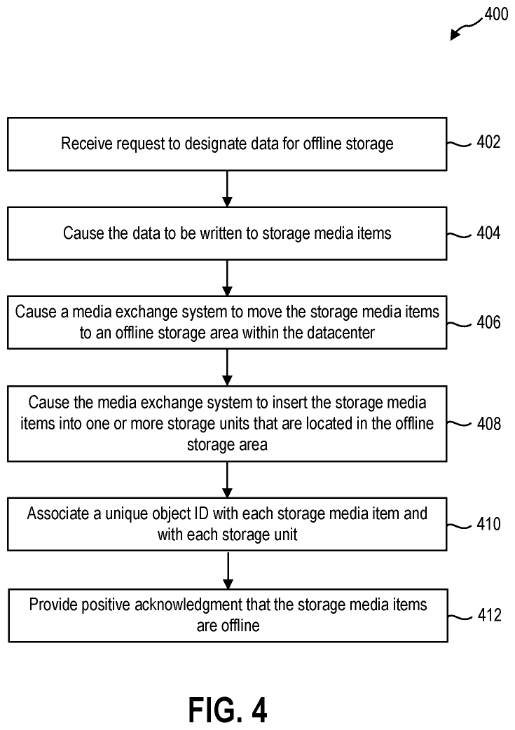

FIG. 4 illustrates an example of a method 400 that can be implemented to move one or more storage media items 304a from a production area 302 of a datacenter 300 to an offline storage area 310 of the datacenter 300. The method 400 will be described in relation to the datacenter 300 shown in FIG. 3. The method 400 can be implemented by a computer system 344 within the datacenter 300. To implement the method 400, the datacenter's computer system 344 can communicate with various other components within the datacenter 300 (e.g., automated systems within the datacenter 300, such as the media exchange system 308).

In some embodiments, a request can be received 402 to designate data 342 that is being stored by the datacenter 300 for offline storage. Alternatively, instead of receiving a specific request, data 342 can be designated for offline storage in response to the occurrence of one or more events. For example, some data 342 can be designated for offline storage after a certain period of time. In this case, once the relevant time period has elapsed, the data 342 can be taken offline.

In response to receiving the request (or detecting the occurrence of a relevant event), the datacenter's computer system 344 can cause 404 the data 342 to be written to one or more storage media items 304a (assuming that the data 342 does not already exist on removable storage media 304). The datacenter's computer system 344 can then cause 406 a media exchange system 308 within the datacenter 300 to move the storage media items 304a to an offline storage area 310 within the datacenter 300.

In addition, the datacenter's computer system 344 can cause 408 the media exchange system 308 within the datacenter 300 to insert the storage media items 304a into one or more storage units 312 that are located in the offline storage area 310. As discussed above, the transfer of the storage media items 304a into the storage units 312 can occur through a unidirectional security system, which ensures that the storage media items 304a are no longer accessible to the media exchange system 308 after the storage media items 304a have been placed into a storage unit 312.

A unique object ID 350 can be associated 410 with each storage media item 304a. In addition, a unique object ID 351 can be associated with each storage unit 312 in which a storage media item 304a is placed. These object IDs 350, 351 can be recorded in a database 321 to facilitate tracking of the storage media items 304a.

The datacenter's computer system 344 can also provide 412 a positive acknowledgement that the storage media items 304a are now offline. In some embodiments, the datacenter's computer system 344 can display a message to the user, via a user interface, indicating that the storage media items 304a are now offline.

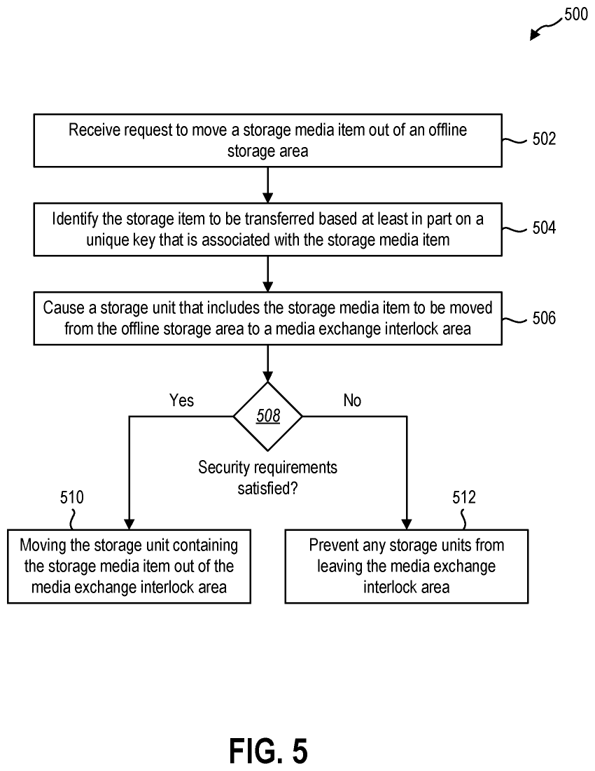

FIG. 5 illustrates an example of a method 500 that can be implemented in response to a request to move one or more storage media items 304a out of the offline storage area 310. As before, the method 500 will be described in relation to the datacenter 300 shown in FIG. 3. The method 500 can be implemented by a computer system 344 within the datacenter 300. To implement the method 500, the datacenter's computer system 344 can communicate with various other components within the datacenter 300.

The method 500 can include receiving 502 a request 354 to move one or more storage media items 304a out of an offline storage area 310. For example, a data owner could request that certain storage media items 304a in the offline storage area 310 be transferred to an offsite location outside of the datacenter 300. As another example, a data owner could request that certain storage media items 304a be restored (e.g., moved back into the production area 302). For each storage media item 304a that is being requested to be transferred out of the offline storage area 310, the request 354 can include a unique key 356 that is associated with the storage media item 304a. For the sake of simplicity, in the discussion of the remainder of the method 500 it will be assumed that a request 354 to move a single storage media item 304a out of the offline storage area 310 has been received 502.

In response to receiving 502 the request 354, the datacenter's computer system 344 can identify 504 the storage media item 304a that is to be transferred based at least in part on the unique key 356 that is associated with the storage media item 304a. The identification 504 of the storage media item 304a can also be based at least in part on user account information 358 that can be included in the request 354.

The datacenter's computer system 344 can cause 506 a storage unit 312 that includes the storage media item 304a to be moved from the offline storage area 310 to a media exchange interlock area 320. As discussed above, before the storage unit 312 that includes the storage media item 304a can be moved outside of the media exchange interlock area 320, a plurality of security requirements should be satisfied. Thus, the method 500 can include determining 508 whether these security requirements have been satisfied. As discussed above, some examples of these security requirements include (i) a requirement that the datacenter's computer system 344 has authorized the storage media items 304a to be moved from the media exchange interlock area 320; (ii) a requirement that the number of storage media items 304a in the media exchange interlock area 320 matches the number of storage media items 304a that are supposed to be leaving; (iii) a requirement that the amount of weight in the media exchange interlock area 320 matches an estimated weight that is calculated based on the number of storage media items 304a that are supposed to be leaving; (iv) a requirement that a security staff member physically unlocks an opening leading out of the media exchange interlock area 320; and (v) a requirement that an opening to the offline storage area 310 be closed.

If it is determined 508 that the security requirements have been satisfied, then the method 500 can include moving 510 the storage unit 312 that includes the storage media item 304a out of the media exchange interlock area 320. On the other hand, if it is determined 508 that the security requirements have not been satisfied, then the method 500 can include preventing 512 any storage units 312 from leaving the media exchange interlock area 320.

In some embodiments, it may not be necessary for all of the security requirements listed above to be satisfied in order to permit the storage unit 312 that includes the storage media item 304a to leave the media exchange interlock area 320. For example, in some embodiments, the storage unit 312 that includes the storage media item 304a can be permitted to leave the media exchange interlock area 320 if some subset of the security requirements has been satisfied.

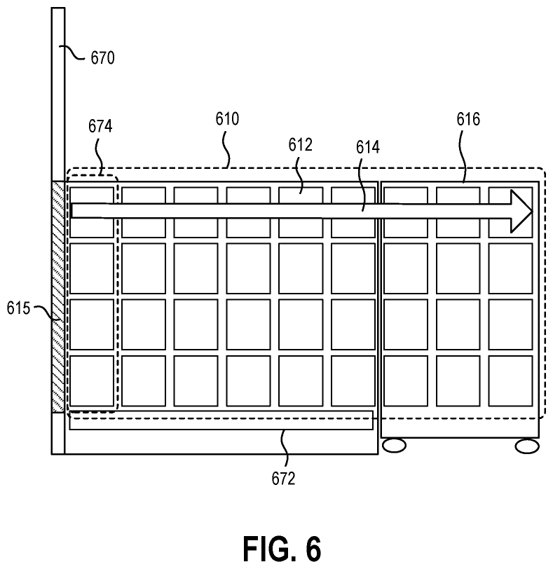

FIG. 6 illustrates an embodiment where some of the storage media items within an offline storage area 610 are loaded onto a mobile cart 616. The various blocks shown in FIG. 6 can represent storage units 612 containing storage media items. In this embodiment, the offline storage area 610 includes a plurality of storage units 612 that are stacked on top of one another.

FIG. 6 shows a boundary 670 (e.g., a wall) between the production area of the datacenter and the offline storage area 610. A unidirectional security system 615 is situated at this boundary 670. Items of storage media can be passed through the unidirectional security system 615 into storage units 612 within the offline storage area 610. As discussed above, the unidirectional security system 615 permits movement of the storage media items into the storage units 612 within the offline storage area 610, but restricts movement of the storage media items out of the storage units 612. In this way, the unidirectional security system 615 prevents an automated system that operates within the production area of the datacenter (e.g., the media exchange system 108 shown in FIG. 1) from being able to access the items of storage media after they have been placed in the storage units 612 in the offline storage area 610.

The offline storage area 610 includes a receiving area 674. An automated system operating within the production area of the datacenter can place storage media items into storage units 612 that are located in the receiving area 674. Because of the unidirectional security system 615, however, such an automated system cannot remove the storage media items from those storage units 612.

The offline storage area 610 includes a conveyor system 672 that is configured to move the storage units 612 in a direction 614 away from the receiving area 674. When the storage units 612 in the receiving area 674 have been filled with storage media items, the conveyor system 672 can shift the storage units 612 in the offline storage area 610 in the direction 614 away from the receiving area 674. Empty storage units 612 can then be placed in the receiving area 674. For example, an automated system operating within the offline storage area 610 can place empty storage units 612 in the receiving area 674. Additional storage media items can then be placed in those storage units 612 until they become full, at which point the process just described can be repeated.

There are many different ways that the conveyor system 672 can be implemented. As an example, in some embodiments the conveyor system 672 can include a spring-loaded mechanism that is designed to force the storage units 612 in the direction 614 away from the receiving area 674. As another example, in some embodiments the conveyor system 672 can include a conveyor belt system, where a belt drive mechanism moves the storage units 612 in the direction 614 away from the receiving area 674. As another example, in some embodiments the conveyor system 672 can include a roller-based system, where the storage units 612 can be placed on a series of bearings that enable them to slide in the direction 614 away from the receiving area 674.

A mobile cart 616 is docked against the end of the conveyor system 672. In the depicted embodiment, the offline storage area 610 includes the mobile cart 616 as well as the region of space occupied by the storage units 612 on the conveyor system 672. When the conveyor system 672 is filled with storage units 612, the conveyor system 672 can shift one or more rows of storage units 612 onto the mobile cart 616. When the mobile cart 616 is filled with storage units 612, the mobile cart 616 can move to a different location and another empty mobile cart 616 can move to the end of the conveyor system 672 in a position to receive additional rows of storage units 612 as they are shifted over.

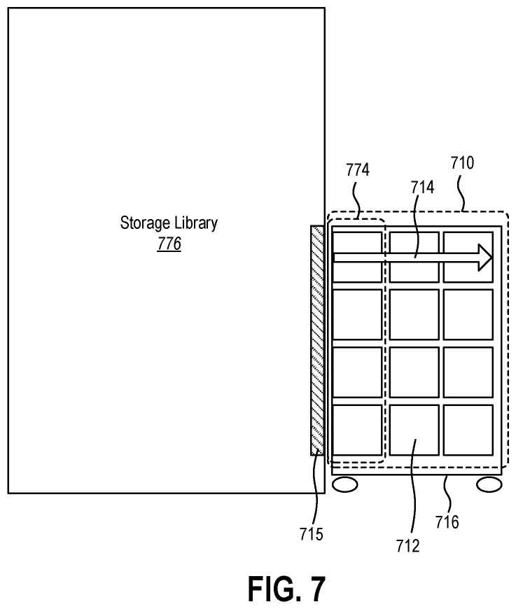

FIG. 7 illustrates aspects of an embodiment corresponding to the second scenario described previously (the scenario that does not require integration with building-scale automation systems). In this embodiment, the offline storage area 710 can be created entirely within a mobile cart 716.

The mobile cart 716 can be configured to dock with a storage library 776 used by a datacenter. When offline storage of particular data is desired, drives within the storage library 776 can write the data to storage media and deliver the storage media to a receiving area 774 of the secure mobile cart 716 via an automated system that is built into the storage library 776.

A unidirectional security system 715 is located at the boundary between the storage library 776 and the mobile cart 716. Items of storage media can be passed through the unidirectional security system 715 into storage units 712 within the mobile cart 716. As discussed above, the unidirectional security system 715 permits movement of the storage media items into the storage units 712 within the mobile cart 716, but restricts movement of the storage media items out of the storage units 712. In this way, the unidirectional security system 715 prevents an automated system that operates within the storage library 776 from being able to access the items of storage media after they have been placed in the storage units 712 in the mobile cart 716.

As noted previously, in the depicted embodiment the offline storage area 710 can be created entirely within the mobile cart 716. The offline storage area 710 includes a receiving area 774. An automated system operating within the storage library 776 can place storage media items into storage units 712 that are located in the receiving area 774. Because of the unidirectional security system 715, however, such an automated system cannot remove the storage media items from those storage units 712.

The mobile cart 716 includes a plurality of storage units 712 that are stacked on top of one another in vertical rows. When the storage units 712 in the receiving area 774 have been filled with storage media items, the storage units 712 in the mobile cart 716 can be shifted in a direction 714 away from the receiving area 774. In some embodiments, this shifting can be caused by an automated system within the storage library 776. As another example, in some embodiments the storage library 776 and/or the mobile cart 716 can include a conveyor system that is configured to shift the storage units 712 in the direction 714 away from the receiving area 774.

When the mobile cart 716 is filled with storage media items, the mobile cart 716 can move to a different location and another empty mobile cart 716 can move into a position to receive additional storage media items from the storage library 776.

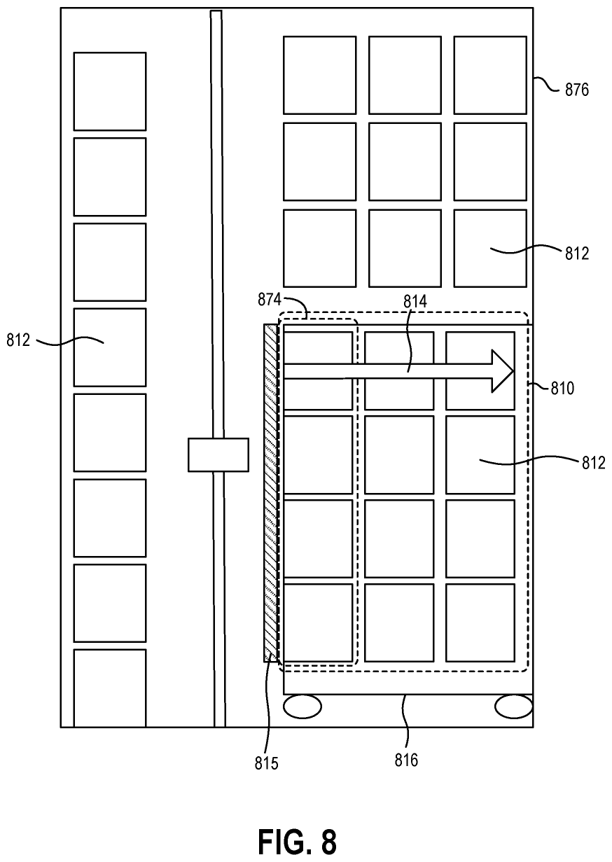

FIG. 8 illustrates an alternative to the embodiment shown in FIG. 7. In this embodiment, the mobile cart 816 can dock inside a storage library 876 used by a datacenter. This embodiment is otherwise similar to the embodiment shown in FIG. 7.

For example, an offline storage area 810 can be created within the mobile cart 816. The offline storage area 810 includes a receiving area 874. An automated system operating within the storage library 876 can place storage media items into storage units 812 that are located in the receiving area 874. Because of the unidirectional security system 815, however, such an automated system cannot remove the storage media items from those storage units 812.

When the storage units 812 in the receiving area 874 have been filled with storage media items, the storage units 812 in the mobile cart 816 can be shifted in a direction 814 away from the receiving area 874. In some embodiments, this shifting can be caused by an automated system within the storage library 876. As another example, in some embodiments the storage library 876 and/or the mobile cart 816 can include a conveyor system that is configured to shift the storage units 812 in the direction 814 away from the receiving area 874.

When the mobile cart 816 is filled with storage units 812, the mobile cart 816 can exit the storage library 876 and move to a different location. Another empty mobile cart 816 can move into a position to receive additional storage media items from the storage library 876.

The storage library 876 is shown with additional storage units 812 outside of the mobile cart 816. In some embodiments, these additional storage units 812 can be placed inside a mobile cart 816 as needed. For example, when an empty mobile cart 816 moves into the storage library 876, an automated system within the storage library 876 can load one or more empty storage units 812 into the mobile cart 816. Storage media items can then be placed into the storage unit(s) 812 through the unidirectional security system 815.

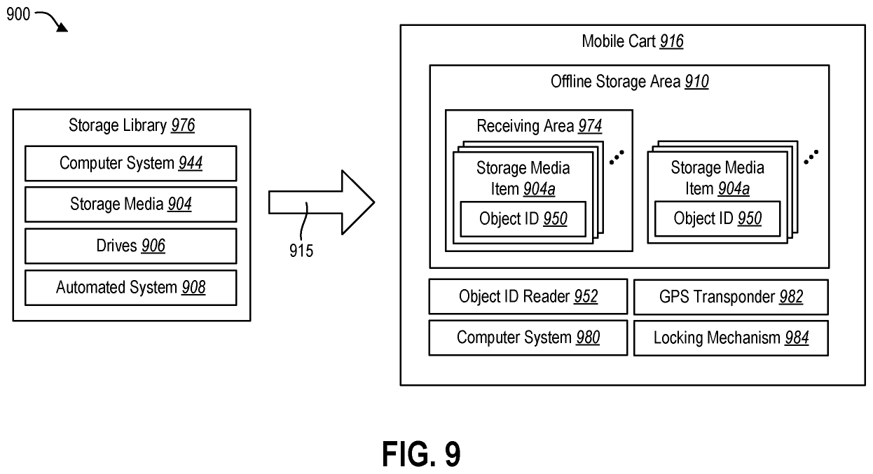

FIG. 9 illustrates an example of a system 900 that includes an offline storage area 910 within a mobile cart 916. The mobile cart 916 can be configured to dock with an existing storage library 976, as discussed previously in connection with FIGS. 7 and 8.

The storage library 976 can include storage media 904 for backing up or archiving data that is stored by the datacenter. The storage library 976 can also include drives 906 that are configured to write backup or archive data to the storage media 904. The storage library 976 can also include an automated system 908 that is configured to transfer storage media items 904a into the mobile cart 916.

The mobile cart 916 includes an offline storage area 910. The offline storage area 910 includes a receiving area 974. The automated system 908 operating within the storage library 976 can place storage media items 904a into the receiving area 974. In some embodiments, the storage media items 904a can be placed into storage units within the receiving area 974. Alternatively, in some embodiments the storage media items 904a can be placed into the receiving area 974 without the use of storage units.

The storage media items 904a can be placed into the receiving area 974 through a unidirectional security system 915, which prevents the automated system 908 from removing the storage media items 904a from the offline storage area 910.

The mobile cart 916 can also include various components that facilitate tracking of the mobile cart 916 and the storage media items 904a within the mobile cart 916. For example, each of the storage media items 904a can be associated with a unique object ID 950. The mobile cart 916 can include an object ID reader 952 that is configured to read the object IDs 950 that are associated with the storage media items 904a. The mobile cart 916 can also include a computer system 980 that is in electronic communication with the object ID reader 952. The computer system 980 can be configured to respond to requests for information about the storage media items 904a within the mobile cart 916. For example, the computer system 980 on a particular mobile cart 916 can be in electronic communication with another computer system 944 utilized by the datacenter (e.g., a computer system 944 within the storage library 976). The computer system 980 on the mobile cart 916 can respond to requests for information from the datacenter's computer system 944 about the storage media items 904a on the mobile cart 916.

The mobile cart 916 can also include a GPS transponder 982 that is configured to determine the position of the mobile cart 916. The computer system 944 on the mobile cart 916 and/or the computer system 944 within the storage library 976 can be in electronic communication with the GPS transponder 982. Either or both of the computer systems 944, 980 can use location information obtained from the GPS transponder 982 to respond to requests for information about the location of the mobile cart 916.

For additional security, the mobile cart 916 can include a locking mechanism 984 to prevent unauthorized access to the mobile cart 916. There are a variety of ways that the locking mechanism 984 can be implemented. In some embodiments, a physical key can be required to unlock the locking mechanism 984, and only authorized personnel are permitted to have the key. In other embodiments, a security code can be required to unlock the locking mechanism 984, and only authorized personnel are permitted to have the security code. The mobile cart 916 can include a keypad, and the security code can be entered via the keypad. In other embodiments, a biometric identifier can be required to unlock the locking mechanism 984. The mobile cart 916 can include a biometric scanner, and the biometric scanner can be programmed to recognize biometric identifiers from authorized personnel (and not from other personnel).

As used herein, the term “storage media item” can refer to one or more articles or units of storage media. For example, if the storage media being used is magnetic tape, the term “storage media item” can refer to one or more magnetic tape cartridges. If the storage media being used are optical discs, the term “storage media item” can refer to one or more optical discs.

The term “automated system” can refer to any component or combination of components that are configured to automatically perform one or more operations (i.e., perform the operation(s) without human assistance). In some embodiments, automated systems can be implemented with one or more robotic systems. Alternatively, in some embodiments, automated systems can be implemented with other types of specialized machines other than robotic systems. Automation can be achieved by various mechanisms, including mechanical, hydraulic, pneumatic, electrical, and computer-driven, and combinations thereof.

The term “production area” can refer to the part(s) of a datacenter that include anything that can be accessed by computing devices external to the datacenter via one or more computer networks (e.g., the Internet). In some embodiments, any part of a datacenter that includes any servers and/or any automated systems (e.g., the media exchange system 108 shown in FIG. 1) that can be accessed by computing devices external to the datacenter can be considered to be part of the production area of the datacenter.

The term “object identifier” can refer to any type of machine-readable identifier, including a barcode, an RFID tag, an NFC tag, or the like.

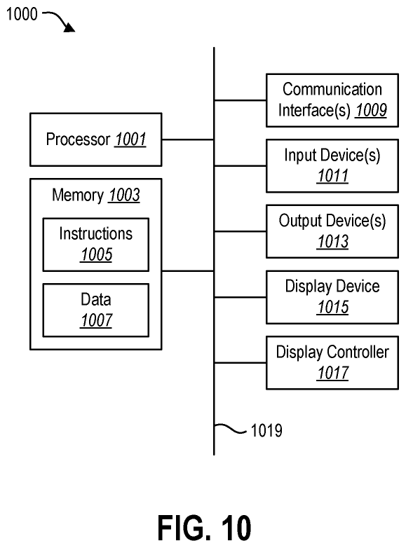

As discussed above, one or more computer systems can be used to implement at least some aspects of the techniques disclosed herein. FIG. 10 illustrates certain components that can be included within a computer system 1000.

The computer system 1000 includes a processor 1001 and memory 1003 in electronic communication with the processor 1001. Instructions 1005 and data 1007 can be stored in the memory 1003. The instructions 1005 can be executable by the processor 1001 to implement some or all of the methods, steps, operations, actions, or other functionality that is disclosed herein. Executing the instructions 1005 can involve the use of the data 1007 that is stored in the memory 1003. Unless otherwise specified, any of the various examples of modules and components described herein can be implemented, partially or wholly, as instructions 1005 stored in memory 1003 and executed by the processor 1001. Any of the various examples of data described herein can be among the data 1007 that is stored in memory 1003 and used during execution of the instructions 1005 by the processor 1001.

Although just a single processor 1001 is shown in the computer system 1000 of FIG. 10, in an alternative configuration, a combination of processors (e.g., an Advanced RISC (Reduced Instruction Set Computer) Machine (ARM) and digital signal processor (DSP) could be used.

The computer system 1000 can also include one or more communication interfaces 1009 for communicating with other electronic devices. The communication interface(s) 1009 can be based on wired communication technology, wireless communication technology, or both. Some examples of communication interfaces 1009 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1000 can also include one or more input devices 1011 and one or more output devices 1013. Some examples of input devices 1011 include a keyboard, mouse, microphone, remote control device, button, joystick, trackball, touchpad, and lightpen. One specific type of output device 1013 that is typically included in a computer system 1000 is a display device 1015. Display devices 1015 used with embodiments disclosed herein can utilize any suitable image projection technology, such as liquid crystal display (LCD), light-emitting diode (LED), gas plasma, electroluminescence, or the like. A display controller 1017 can also be provided, for converting data 1007 stored in the memory 1003 into text, graphics, and/or moving images (as appropriate) shown on the display device 1015. The computer system 1000 can also include other types of output devices 1013, such as a speaker, a printer, etc.

The various components of the computer system 1000 can be coupled together by one or more buses, which can include a power bus, a control signal bus, a status signal bus, a data bus, etc. For the sake of clarity, the various buses are illustrated in FIG. 10 as a bus system 1019.

At least some aspects of the techniques disclosed herein can be implemented using computer hardware, software, firmware, or any combination thereof, unless specifically described as being implemented in a specific manner. Any features described as modules, components, or the like can also be implemented together in an integrated logic device or separately as discrete but interoperable logic devices. If implemented in software, the techniques can be realized at least in part by a non-transitory computer-readable medium having computer-executable instructions stored thereon that, when executed by at least one processor, perform some or all of the steps, operations, actions, or other functionality disclosed herein. The instructions can be organized into routines, programs, objects, components, data structures, etc., which can perform particular tasks and/or implement particular data types, and which can be combined or distributed as desired in various embodiments.

The term “processor” can refer to a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, or the like. A processor can be a central processing unit (CPU). In some embodiments, a combination of processors (e.g., an ARM and DSP) could be used to implement some or all of the techniques disclosed herein.

The term “memory” can refer to any electronic component capable of storing electronic information. For example, memory may be embodied as random access memory (RAM), read-only memory (ROM), magnetic disk storage media, optical storage media, flash memory devices in RAM, on-board memory included with a processor, erasable programmable read-only memory (EPROM), electrically erasable programmable read-only memory (EEPROM) memory, registers, and so forth, including combinations thereof.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

The term “determining” (and grammatical variants thereof) can encompass a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there can be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A system for facilitating storage of data from an automated system of a datacenter to a secure offline storage space to create secured offline data that is inaccessible by the automated system or any computing devices external to the datacenter, the automated system operating within a production area of the datacenter, the automated system accessible by one or more computing devices external to the datacenter with a computer network, the system comprising:
an offline storage area for the datacenter, wherein the offline storage area is distinct from a production area of the datacenter;
an offline storage unit that is configured to include storage media items that have been designated for offline storage, wherein the storage media items comprise data from the datacenter, and wherein the automated system is configured to transfer the storage media items into the offline storage unit; and
a unidirectional security system that prevents the automated system from removing the storage media items from the offline storage unit after the storage media items have been moved into the offline storage area, thereby making the storage media items inaccessible to the automated system.

2. The system of claim 1, wherein:
the offline storage unit comprises a container with a plurality of slots; and
the unidirectional security system comprises a spring-loaded detent in front of each slot.

3. The system of claim 1, wherein:
object identifiers are associated with the storage media items; and
the offline storage area comprises an object identifier reader that is configured to read the object identifiers.

4. The system of claim 1, further comprising a computer system that is configured to:
receive a request to move a storage media item out of the offline storage area, wherein the request comprises a unique key associated with the storage media item; and
identify the storage media item based at least in part on the unique key.

5. The system of claim 1, further comprising a media exchange interlock area that is adjacent to the offline storage area, wherein:
any storage units that are scheduled to leave the datacenter are transferred from the offline storage area into the media exchange interlock area; and
no items in the media exchange interlock area are permitted to leave the media exchange interlock area unless a plurality of security requirements have been satisfied.

6. The system of claim 1, further comprising a computer system and a media exchange interlock area that is adjacent to the offline storage area, wherein the computer system is configured to:
cause an X-ray machine within the media exchange interlock area to take an X-ray of the media exchange interlock area in response to a plurality of storage units being moved into the media exchange interlock area; and
perform image processing on the X-ray to determine how many storage media items are in the media exchange interlock area.

7. The system of claim 1, further comprising a computer system and a media exchange interlock area that is adjacent to the offline storage area, wherein the computer system is configured to:
cause a scale within the media exchange interlock area to weigh a plurality of storage units in the media exchange interlock area in response to the plurality of storage units being moved into the media exchange interlock area; and
determine whether a measured weight of the plurality of storage units matches an estimated weight of the plurality of storage units based on the storage media items that have been authorized to leave the offline storage area.

8. The system of claim 1, further comprising an additional automated system within the offline storage area that is configured to:
transfer the storage media items between a plurality of storage units; and
transfer the plurality of storage units from the offline storage area to a media exchange interlock area that is adjacent to the offline storage area.

9. The system of claim 1, further comprising:
a media exchange interlock area that is adjacent to the offline storage area; and
an additional automated system within the media exchange interlock area, wherein the additional automated system is configured to transfer a plurality of storage units from the media exchange interlock area to a loading dock for transfer outside of the datacenter.

10. The system of claim 1, wherein the offline storage area comprises:
a receiving area that is positioned to receive the storage media items from the automated system; and
a conveyor system that is configured to move the storage media items in a direction away from the receiving area as additional storage media items are added to the receiving area.

11. The system of claim 1, wherein the offline storage unit comprises a mobile cart, and wherein the offline storage area is located within the mobile cart.

12. The system of claim 11, wherein the mobile cart is configured to dock with a storage library of the datacenter.

13. The system of claim 11, wherein:
the automated system is part of a storage library of the datacenter;
the mobile cart comprises a receiving area that is positioned to receive the storage media items from the automated system of the storage library; and
the unidirectional security system is positioned at a boundary between the storage library of the datacenter and the receiving area.

14. The system of claim 11, wherein:
object identifiers are associated with the storage media items; and
the mobile cart comprises an object identifier reader that is configured to read the object identifiers.

15. The system of claim 11, wherein the mobile cart comprises at least one of:
a global positioning system (GPS) transponder; or
a locking mechanism.

16. A method for facilitating secure transfer of offline data out of an offline storage area of a datacenter, comprising:
receiving a request to move a storage media item out of the offline storage area of the datacenter, wherein the request comprises a unique key associated with the storage media item;
identifying the storage media item to be moved based at least in part on the unique key;
causing a storage unit comprising the storage media item to be moved from the offline storage area to a media exchange interlock area;
determining whether a plurality of security requirements associated with the media exchange interlock area have been satisfied; and
moving the storage unit out of the media exchange interlock area only after confirming that the plurality of security requirements associated with the media exchange interlock area have been satisfied.

17. The method of claim 16, wherein determining whether the plurality of security requirements have been satisfied comprises:
determining whether a datacenter computer system has authorized the storage unit to be removed from the offline storage area; and
at least one additional security requirement selected from:
determining whether a number of storage media items in the media exchange interlock area matches the number of storage media items that are supposed to be leaving the offline storage area;
determining whether an amount of weight in the media exchange interlock area matches an estimated weight that is calculated based on the number of storage media items that are supposed to be leaving the offline storage area;
determining whether a security staff member has physically unlocked an opening leading out of the media exchange interlock area; or
determining whether an opening to the offline storage area is closed.

18. The method of claim 16, wherein:
the method is implemented by a computer system associated with the datacenter;
the computer system does not support queries to list contents of the offline storage area; and
the method further comprises denying an additional request based at least in part on determining that no key has been submitted with the additional request or that a key submitted with the additional request is invalid.

19. A mobile cart for facilitating secure offline storage of data from a datacenter, comprising:
an offline storage area for the datacenter;
a receiving area that is configured to receive storage media items from an automated system of a storage library within the datacenter, wherein the storage media items comprise data from the datacenter;
a unidirectional security system that prevents the automated system from removing the storage media items from the mobile cart after the storage media items have been placed in the receiving area;
a conveyor system that is configured to move the storage media items in a direction away from the receiving area as additional storage media items are added to the receiving area;
an object identifier reader that is configured to read object identifiers that are associated with the storage media items; and
a computer system that is in electronic communication with the object identifier reader and that is configured to respond to requests for information about the storage media items within the mobile cart.

20. The mobile cart of claim 19, wherein the mobile cart is configured to dock with the storage library of the datacenter.
